(19) United States
(12) Patent Application Publication
(10) Pub. No.: US 2009/0224073 A1
(43) Pub. Date: Sep. 10, 2009

(54) Multi-purpose sprayer gun

(76) Inventor: Pai-Chou Hsieh, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/074,669

(22) Filed: Mar. 4, 2008

(51) Int. Cl. A62C 31/02

(52) U.S. Cl. 239/394

(57) ABSTRACT

A sprayer gun includes a housing form on top of a handle and having a conduit for receiving water from the handle, a revolving ring rotatably attached to the housing and having a number of openings for aligning with the conduit of the housing, a sealing ring engaged in the conduit of the housing and having a bore for aligning with either of the openings of the revolving ring, an actuating rod slidably disposed in the housing and coupled to a trigger which may move the actuating rod toward or away from the revolving ring, and the actuating rod includes a plug for engaging into the bore of the sealing ring and for sealingly engaging with the sealing ring and for controlling the water to flow out through the bore of the sealing ring.

### BACKGROUND OF THE INVENTION

1. Field of the Invention

The present invention relates to a multi-purpose sprayer gun, and more particularly to a multi-purpose sprayer gun including a simplified structure for reducing the manufacturing cost for the sprayer gun and for allowing the sprayer gun to be easily and quickly assembled.

2. Description of the Prior Art

Typical sprayer guns comprise a revolving ring rotatably attached to a main body, a water control rod slidably disposed in the main body and having a collar for engaging with the revolving ring and for controlling the outwardly water flowing pattern, and a press trigger handle pivotally attached to the main body and coupled to the water control rod to actuate the collar of the water control rod to engage with the revolving ring.

For example, U.S. Pat. No. 4,666,085 to Liaw discloses one of the typical multiple purpose water spray guns comprise a seal plate attached to a main body for covering the circular front of the main body, and two or more water seal rings engaged into a water supply pipe of the main body before a revolving ring is rotatably attached or coupled to the main body.

However, the seal plate and the water seal rings are required and should be attached or coupled to the main body such that the typical sprayer gun may not be easily and quickly assembled and such that the manufacturing cost for the typical sprayer gun may not be reduced.

U.S. Pat. No. 5,598,978 to Wang discloses another typical garden sprinkler head comprising a water distributor plate integrally secured to the inner side of a top discharge cover by such as ultrasonic welding processes before the top discharge cover is rotatably attached or coupled to the nozzle head of a lever controlled nozzle.

However, the water distributor plate is required and should be attached or coupled to the top discharge cover such that the typical sprayer gun may not be easily and quickly assembled and such that the manufacturing cost for the typical sprayer gun also may not be reduced.

U.S. Pat. No. 6,719,219 to Wang discloses a further typical sprayer nozzle having multiple spray pattern and comprising a front casing welded or secured to a front housing of the spray gun body, a rotor rotatably attached or coupled to the front housing with a pivotal stud and having a number of passages of different patterns formed in the rotor, and a control ferrule rotatably attached or coupled to the front housing and meshed or engaged with the rotor for rotating the rotor relative to the front housing and for controlling the outwardly water flowing patterns.

However, the rotor and the control ferrule may complicate the structure of the typical sprayer nozzle and should be attached or coupled to the front housing and the front casing such that the typical sprayer gun may not be easily and quickly assembled and such that the manufacturing cost for the typical sprayer gun also may not be reduced.

The present invention has arisen to mitigate and/or obviate the afore-described disadvantages of the conventional multi-purpose sprayer guns.

### SUMMARY OF THE INVENTION

The primary objective of the present invention is to provide a multi-purpose sprayer gun including a simplified structure for reducing the manufacturing cost for the sprayer gun and for allowing the sprayer gun to be easily and quickly assembled or manufactured.

In accordance with one aspect of the invention, there is provided a sprayer gun comprising a sprayer gun body including a handle for being grasped by a user, and including a passage formed in the handle, and including a housing provided on top of the handle and having a conduit formed in the housing and communicating with the passage of the handle for receiving the water from the passage of the handle, a revolving ring rotatably attached to a front portion of the housing and including a plurality of openings formed in the revolving ring for changeably aligning with the conduit of the housing by rotating the revolving ring relative to the housing, a sealing ring engaged in the conduit of the housing for engaging with the revolving ring and for making a water tight seal between the housing and the revolving ring, the sealing ring including a bore formed therein for selectively aligning with either of the openings of the revolving ring, an actuating rod slidably disposed in the conduit of the housing and including a sealing block disposed on the actuating rod and secured to the housing for making a water tight seal between the housing and the actuating rod and for guiding the water to flow from the passage of the handle to a front portion of the conduit of the housing, and a trigger pivotally attached to the housing with a pivot shaft and coupled to the actuating rod for moving the actuating rod relative to the conduit of the housing and for moving the actuating rod toward or away from the revolving ring, and the actuating rod includes a plug provided on a front portion of the actuating rod for selectively engaging into the bore of the sealing ring and for sealingly engaging with the sealing ring and for effectively controlling the water to flow out through the bore of the sealing ring and to flow out through either of the openings of the revolving ring, the sprayer gun includes a simplified structure for reducing the manufacturing cost and for allowing the sprayer gun to be easily and quickly assembled or manufactured.

The actuating rod includes a water guide head provided on the front portion of the actuating rod for engaging with the sealing ring, and the plug is extended outwardly and forwardly from the water guide head for selectively engaging into the bore of the sealing ring and for effectively controlling the water to flow out through the bore of the sealing ring.

The actuating rod includes an outer thread formed on a rear portion of the actuating rod for engaging with a lock nut which is engaged with the trigger for coupling the actuating rod to the trigger and for allowing the actuating rod to be actuated or moved by the trigger.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a multi-purpose sprayer gun in accordance with the present invention;

FIG. 2 is a side plan schematic view of the multi-purpose sprayer gun, in which a portion of the multi-purpose sprayer gun has been cut off for showing an inner structure of the multi-purpose sprayer gun; and

FIG. 3 is a side plan schematic view similar to FIG. 2 illustrating the operation of the multi-purpose sprayer gun.

### DETAILED DESCRIPTION OF THE PREFERRED EMBODIMENT

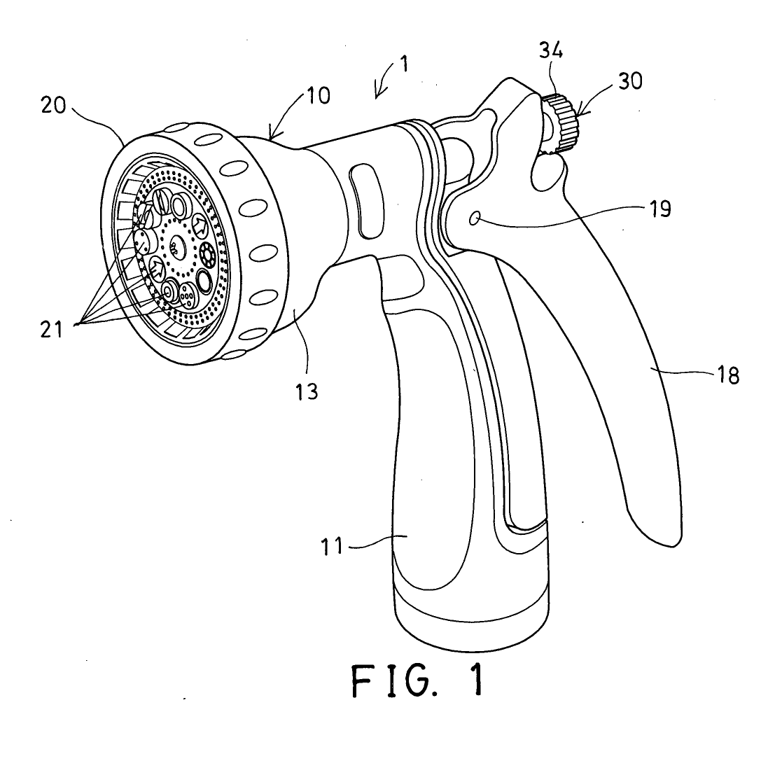

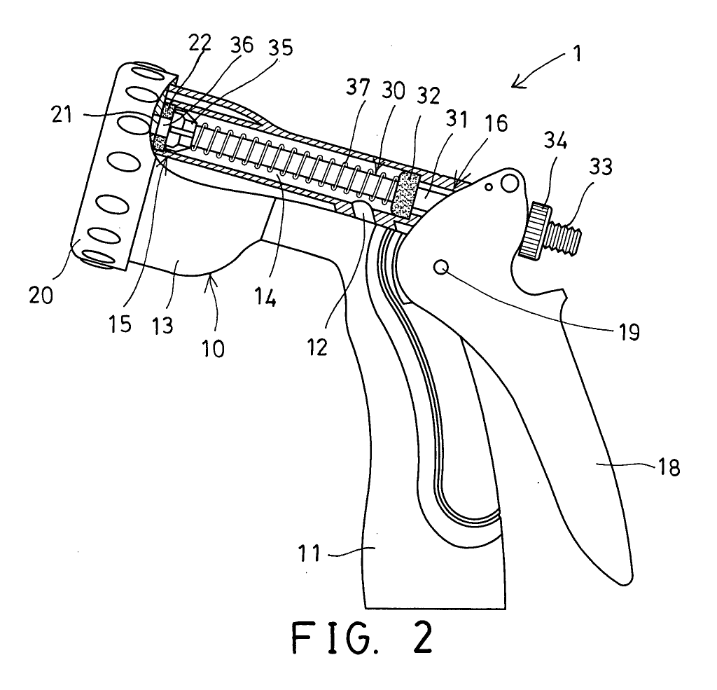

Referring to the drawings, and initially to FIGS. 1 and 2, a multi-purpose sprayer gun 1 in accordance with the present invention comprises a sprayer gun body 10 including a handle 11 for being grasped or held by the users, and including a passage 12 formed in the handle 11 for coupling to a water reservoir (not shown), and including a housing 13 formed or provided on top of the handle 11 and having a conduit 14 formed in the housing 13 and communicating with the passage 12 of the handle 11 for receiving the water from the passage 12 of the handle 11 and for allowing the water to selectively flow out through the conduit 14 of the housing 13.

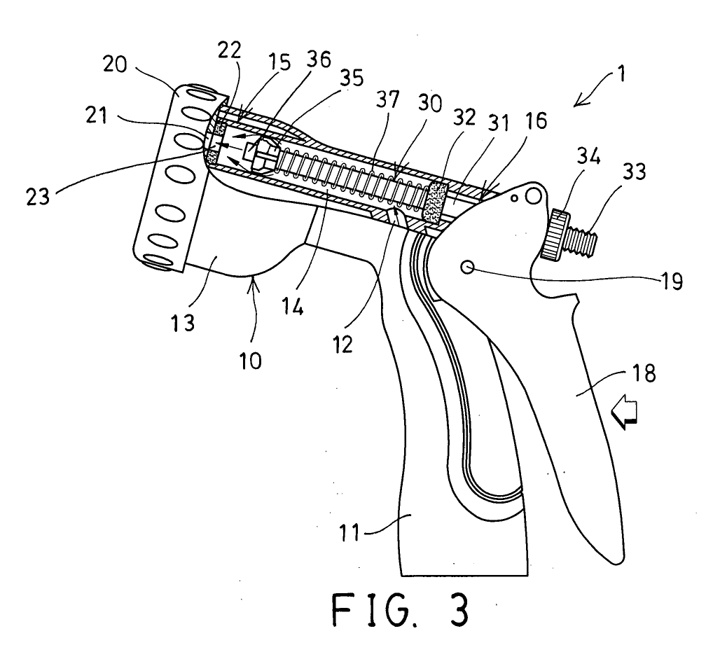

A revolving ring 20 is rotatably attached to the front portion of the housing 13 and includes a number of orifices or openings 21 of different patterns formed in the revolving ring 20 and arranged circularly or in a circle for selectively or changeably aligning with the conduit 14 of the housing 13 (FIGS. 2, 3) and for allowing the water to selectively flow out through either of the openings 21 of the revolving ring 20 by rotating the revolving ring 20 relative to the housing 13. A gasket or sealing ring 22 is disposed or engaged in the front portion 15 of the conduit 14 of the housing 13 for engaging with the revolving ring 20 and for making a water tight seal between the housing 13 and the revolving ring 20. The sealing ring 22 includes an orifice or bore 23 formed therein for selectively or changeably aligning with either of the openings 21 of the revolving ring 20.

A control means or device 30 includes an actuating rod 31 slidably disposed in the conduit 14 of the housing 13, and includes a gasket or sealing block 32 disposed on the actuating rod 31 and engaged or secured in the rear portion 16 of the conduit 14 of the housing 13 for making a water tight seal between the housing 13 and the actuating rod 31 and for preventing the water to flow through the rear portion 16 of the conduit 14 of the housing 13 and for guiding the water to flow from the passage 12 of the handle 11 and to flow out through the front portion 15 of the conduit 14 of the housing 13, and includes an outer thread 33 formed or provided on the rear or one end portion of the actuating rod 31 for threading or engaging with a lock nut 34.

A hand grip or trigger 18 is rotatably or pivotally attached to the rear portion of the housing 13 with such as a pivot shaft 19, and the rear portion of the actuating rod 31 is engaged through the trigger 18 and engaged with or coupled to the trigger 18 with the lock nut 34 for allowing the actuating rod 31 to be actuated or moved along or relative to the conduit 14 of the housing 13 with the trigger 18 and for allowing the actuating rod 31 to be moved toward or away from the revolving ring 20 and/or the sealing ring 22. The above-described structure is typical and will not be described in further details.

The actuating rod 31 further includes a water guide head 35 formed or provided on the front or other end portion of the actuating rod 31 for selectively engaging with the revolving ring 20 and/or the sealing ring 22, and further includes a plug 36 extended outwardly therefrom, such as extended outwardly and forwardly from the water guide head 35 for selectively engaging into the bore 23 of the sealing ring 22 and for sealingly engaging with the sealing ring 22 and thus for effectively controlling the water to selectively flow out through the bore 23 of the sealing ring 22 and then to selectively or changeably flow out through either of the openings 21 of the revolving ring 20. A spring member 37 may be engaged onto the actuating rod 31 and engaged between the sealing block 32 and the water guide head 35 for selectively biasing or forcing the water guide head 35 and the plug 36 toward the sealing ring 22 after the actuating rod 31 has been moved rearwardly relative to the housing and when the trigger 18 is released by the user.

It is to be noted that it is only required to form and provide a plug 36 from the water guide head 35 for selectively engaging into the bore 23 of the sealing ring 22 and for sealingly engaging with the sealing ring 22 and thus for effectively controlling the water to selectively flow out through the bore 23 of the sealing ring 22 and then to selectively or changeably flow out through either of the openings 21 of the revolving ring 20, such that the multi-purpose sprayer gun 1 in accordance with the present invention may include a greatly simplified structure for reducing the manufacturing cost for the sprayer gun 1 and for allowing the sprayer gun 1 to be easily and quickly assembled.

Accordingly, the multi-purpose sprayer gun in accordance with the present invention includes a simplified structure for reducing the manufacturing cost for the sprayer gun and for allowing the sprayer gun to be easily and quickly assembled.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprayer gun comprising:
a sprayer gun body including a handle for being grasped by a user, and including a passage formed in said handle, and including a housing provided on top of said handle and having a conduit formed in said housing and communicating with said passage of said handle for receiving the water from said passage of said handle,
a revolving ring rotatably attached to a front portion of said housing and including a plurality of openings formed in said revolving ring for changeably aligning with said conduit of said housing by rotating said revolving ring relative to said housing,
a sealing ring engaged in said conduit of said housing for engaging with said revolving ring and for making a water tight seal between said housing and said revolving ring, said sealing ring including a bore formed therein for selectively aligning with either of said openings of said revolving ring,
an actuating rod slidably disposed in said conduit of said housing and including a sealing block disposed on said actuating rod and secured to said housing for making a water tight seal between said housing and said actuating rod and for guiding the water to flow from said passage of said handle to a front portion of said conduit of said housing, and
a trigger pivotally attached to said housing with a pivot shaft and coupled to said actuating rod for moving said actuating rod relative to said conduit of said housing and for moving said actuating rod toward or away from said revolving ring, and
said actuating rod including a plug provided on a front portion of said actuating rod for selectively engaging into said bore of said sealing ring and for sealingly engaging with said sealing ring and for controlling the water to flow out through said bore of said sealing ring and to flow out through either of said openings of said revolving ring.

2. The sprayer gun as claimed in claim 1, wherein said actuating rod includes a water guide head provided on the front portion of said actuating rod for engaging with said sealing ring, and said plug is extended outwardly and forwardly from said water guide head.

3. The sprayer gun as claimed in claim 1, wherein said actuating rod includes an outer thread formed on a rear portion of said actuating rod for engaging with a lock nut which is engaged with said trigger for coupling said actuating rod to said trigger.
